(19) United States
(12) Patent Application Publication
(10) Pub. No.: US 2014/0339280 A1
(43) Pub. Date: Nov. 20, 2014

(54) Method and Device for Scribing and Breaking Glass Substrate

(71) Applicant: Shenzhen China Star Optoelectronics Technology Co., Ltd., Shenzhen, Guangdong (CN)

(72) Inventor: Liang Xu, Shenzhen City (CN)

(73) Assignee: Shenzhen China Star Optoelectronics Technology Co., Ltd., Shenzhen, Guangdong (CN)

(21) Appl. No.: 13/978,901

(22) PCT Filed: Jun. 24, 2013
(86) PCT No.: PCT/CN2013/077766

§ 371 Date: Jul. 10, 2013

(30) Foreign Application Priority Data
May 20, 2013 (CN) 201310186373.8

(51) Int. Cl. C03B 33/02; B26F 3/00

(52) U.S. Cl. CPC C03B 33/02; B26F 3/002
USPC 225/2; 225/96

(57) ABSTRACT

The present invention discloses a method for scribing and breaking a glass substrate and related device. The method includes: scribing the glass substrate to form a scribing notch; making a transmission medium of supersonic waves contact the scribing notch; transmitting supersonic waves to the scribing notch via the transmission medium to break the scribed glass substrate under an effect of supersonic waves. The present invention adjusts the frequency of the supersonic waves to make the frequency close to the natural frequency of the scribing notch such that they resonate together. Therefore, the resonation force is uniformly applied on all scribing notch. Therefore, this resonation force can break the scribed glass substrate along the scribing notch beautifully without any damages on the scribing notch and terminals.

### BACKGROUND OF THE INVENTION

1. Field of the Invention

The invention relates to a glass substrate, and more particularly, to a method for scribing and breaking a glass substrate and related device.

2. Description of the Prior Art As the progress of this information society, people have greater demands on displays. In order to meet these demands, several flat displays are introduced. For example, LCD (liquid crystal display), PDP (plasma display panel), and OLED (organic light-emitting diode) displays are developed. In these flat displays, LCD displays are widely utilized because of its low weight, volume, and low power consumption.

A trend, which is narrow side frame design, has become more and more popular in the flat display field. The widths of the side frame of the TFT-LCD or OLED displays become narrower to meet customers' favor. For example, from the beginning the width of the side frames may be 10 mm, and it evolves to smaller than 10 mm, smaller than 5 mm. In nowadays, some side frame whose width is smaller than 3 mm is introduced.

Narrow side frame looks beautiful. However, this design is not easy to produce. A lot of problems are encountered, especially in the scribing and breaking procedure.

In the related art, a dry scribing method which utilizes a penett is adopted. As shown in FIG. 1, through a scribing procedure, a scribing notch 102 having a certain depth is formed on the glass substrate 101. However, at this time, the glass substrate 101 has not been processed by a breaking procedure. Therefore, a breaking procedure should be applied on the scribed glass substrate 101.

In the related art, the breaking procedure is often processed by a mechanical ways. For example, a collision method and a clipping method are often applied.

As shown in FIG. 2a and FIG. 2b, the collision method is to use a collision head 203 to collide with different positions closed to the scribing notch 202 of the glass substrate. Through these collisions, the glass substrate 201 is broken along the scribing notch 202. But the disadvantage of the collision method is: the collision forces applied on the positions are not equal, and the collisions do not occur at the same time. The glass substrate 201 is entirely broken at a certain time spot. Damages to the scribing notch are easily introduced.

As shown in FIG. 3, the clipping method is to use multiple clips 303, which are stringed by a shaft 304. These clips 303 can be controlled to be open or close. The clips 303 are utilized to clip the glass substrate 301 and then pull it down. However, the disadvantage of the clip method is: the opening and closing of each clip 303 is accomplished by utilizing air pressure to control each of the gates. Because air pressure is utilized, it is hard to control every clip 303 to be open and closed at the same time. Especially, the closing timing is very hard to control. Furthermore, the included angle of each clip 303 is hard to control to be equal. This makes the timings and forces applied on the glass substrate 301 by the clips 303 inconsistent. Furthermore, the force applied on the clipping positions of the glass substrate 301 may be larger than other positions. These inconsistencies may introduce damages of the scribing notch of the glass substrate 301.

In addition, the terminals and the scribing notch of a narrow-side-frame flat display are very close to each other. The above-mentioned damage of the scribing notch may hurt the terminals such that the driving signals cannot be inputted normally.

### SUMMARY OF THE INVENTION

It is therefore one of the primary objectives of the claimed invention to provide a method and device for scribing and breaking glass substrate, in order to solve the above-mentioned problem.

According to an exemplary embodiment of the claimed invention, a method for scribing and breaking a glass substrate is disclosed. The method comprises: scribing the glass substrate to form a scribing notch; making a transmission medium of supersonic waves contact the scribing notch; transmitting supersonic waves to the scribing notch via the transmission medium to break the scribed glass substrate under an effect of supersonic waves.

Furthermore, the step of scribing the glass substrate to form the scribing notch comprises: spraying liquids on the scribing notch such that some liquids are congealed on the scribing notch.

Furthermore, the transmission medium is selected from a group consisting of air, glass, water, methyl, ethanol, glycol, acetone, or isopropanol.

Furthermore, the liquids utilized by the spraying device is water.

Furthermore, the liquids utilized by the spraying device is selected from a group consisting of methyl, ethanol, glycol, acetone, or isopropanol.

According to an exemplary embodiment of the claimed invention, a device for scribing and breaking a glass substrate is disclosed. The device comprises: a loading portion, for loading the glass substrate and moves the glass substrate to an assembling area; a scribing device, positioned on an upper of a scribing zone, for scribing the glass substrate to form a scribing notch when the glass substrate arrives the scribing zone; a supersonic wave generator, positioned on an upper of a breaking zone, for breaking supersonic waves when the glass substrate arrives the breaking zone; a transmission medium, for transferring the supersonic waves to the scribing notch to break the scribed glass substrate under an effect of supersonic waves.

Furthermore, the device further comprises a spraying device, positioned above the scribing device, for spraying liquids on the scribing notch.

Furthermore, the transmission medium is selected from a group consisting of air, glass, water, methyl, ethanol, glycol, acetone, or isopropanol.

Furthermore, the liquids utilized by the spraying device is selected from a group consisting of methyl, ethanol, glycol, acetone, or isopropanol.

The present invention adjusts the frequency of the supersonic waves to make the frequency close to the natural frequency of the scribing notch such that they resonate together. Therefore, the resonation force is uniformly applied on all scribing notch. Therefore, this resonation force can break the scribed glass substrate along the scribing notch beautifully without any damages on the scribing notch and terminals. Furthermore, after the breaking procedure, the natural frequency of the glass substrate is larger than that of the glass substrate before the breaking procedure. Therefore, the supersonic waves no longer influence the glass substrate after the breaking procedure, and make the breaking portions uniformly. In addition, if the transmission medium is air or solid transparent material, it can be sprayed to the scribing notch. In the effect of the supersonic waves, the micro foam of liquids condensed on the scribing notch will be enlarged and closed very quickly such that these foams are collided to each other. This makes the breaking procedure easier.

### BRIEF DESCRIPTION OF THE DRAWINGS

FIG. 1 is a diagram of a scribed glass substrate according to the related art.

FIG. 2a is a diagram illustrating a collision method for breaking a scribed glass substrate according to the related art.

FIG. 2b is a diagram showing a scribing notch damage when the collision method is applied.

FIG. 3 is a diagram illustrating a clip method for breaking a scribed glass substrate according to the related art.

FIG. 4 is a diagram of a device for scribing and breaking a glass substrate according to a first embodiment of the present invention.

FIG. 5 is a diagram of a device for scribing and breaking a glass substrate according to a second embodiment of the present invention.

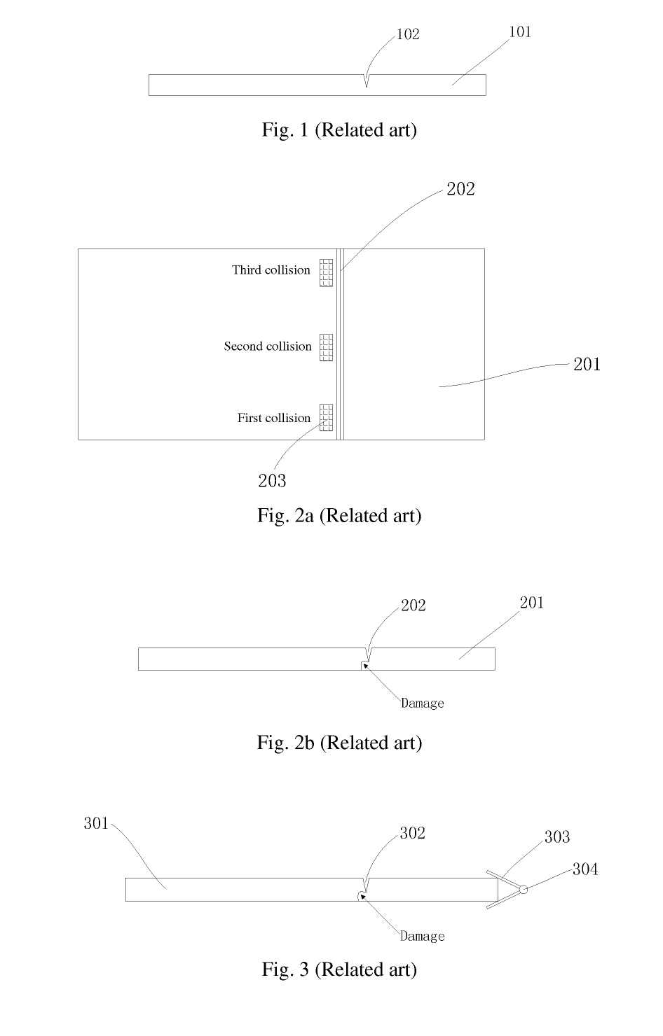

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

### Embodiment 1

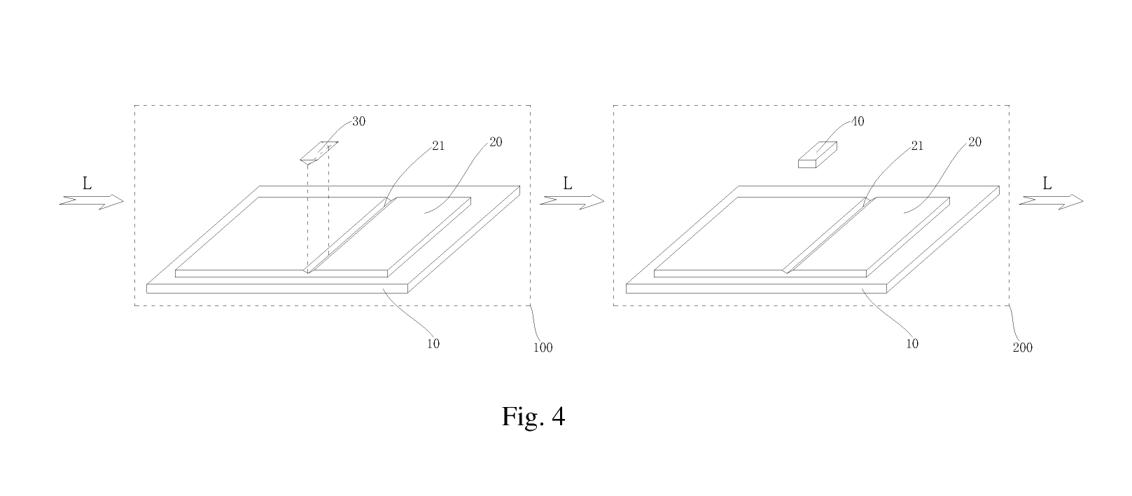

FIG. 4 is a diagram of a device for scribing and breaking a glass substrate according to a first embodiment of the present invention.

As shown in FIG. 4, the device for scribing and breaking comprises a loading portion 10. The loading portion 10 is used to load a glass substrate 20 to an assembling area (not shown) along the route L. A scribing zone 100 and a breaking zone 200 are respectively positioned on the route L.

After the loading portion 10 loads the glass substrate 20, it moves along the route L. Therefore, the glass substrate 20 is scribed by the scribing zone 100. The scribing zone 100 comprises a scribing device 30, which is positioned on the upper of the scribing zone. When the glass substrate 20 arrives a designated scribing position, the scribing device 30 is above the glass substrate 20. In this way, the scribing device 30 can scribe the glass substrate 20 along a predetermined scribing line through a transmission device (such as a motor) to form a scribing notch 21. In an embodiment, a penett could be used as the scribing device.

After the glass substrate 20 is scribed, the loading portion 10 loading the glass substrate 20 continuously moves along the route L. A breaking procedure is applied on the scribed glass substrate 20 in the breaking zone 200. The breaking zone 200 at least comprises a supersonic wave generator 40. The supersonic wave generator 40 is positioned on the upper of the breaking zone. When the glass substrate 20 arrives a designated breaking position, the scribing device 30 is above the glass substrate 20. (the scribing notch 21 is located under the supersonic wave generator 40). The supersonic wave generator 40 is adjusted to have an appropriate output power to generate supersonic waves. The supersonic waves are transferred to the scribing notch 21 via a transmission medium (not shown) such that the scribed glass substrate 20 is broken under the effect of supersonic waves. Please note, the transmission medium can be transparent materials, such as air, glass, water, methyl, ethanol, glycol, acetone, or isopropanol. In order to improve the operation and reduce the cost, in this embodiment, the transmission medium is air. It should be noticed that if the transmission medium is a solid transparent material, such as glasses, one end of the transmission medium can be placed to tightly touch the scribing notch 21 of the glass substrate 20 and the other end of the transmission medium can be placed to tightly touch the supersonic wave generator 40. In this way, the supersonic waves can be successfully transferred to the scribing notch 21. If the transmission medium is a liquid transparent material, such as water, in the breaking zone 40, the loading portion 10 and the glass substrate 20 can be soaked in the liquid transmission medium such that the supersonic waves can be successfully transferred to the scribing notch 21 via the liquid transmission medium.

In this embodiment, the frequency of the supersonic waves generated by the supersonic wave generator 40 is adjusted to a frequency close to a natural frequency of the scribing notch 21 such that they can resonate together. Therefore, the resonation force is uniformly applied on all scribing notch. Therefore, this resonation force can break the scribed glass substrate along the scribing notch beautifully without any damages on the scribing notch and terminals. Furthermore, after the breaking procedure, the natural frequency of the glass substrate 20 is larger than that of the glass substrate 20 before the breaking procedure. Therefore, the supersonic waves generated by the supersonic wave generator 40 no longer influence the glass substrate 20 after the breaking procedure, and make the breaking portions uniformly. In addition, the frequency of the supersonic waves can be adjusted to control the forces applied on the scribing notch 21.

### Embodiment 2

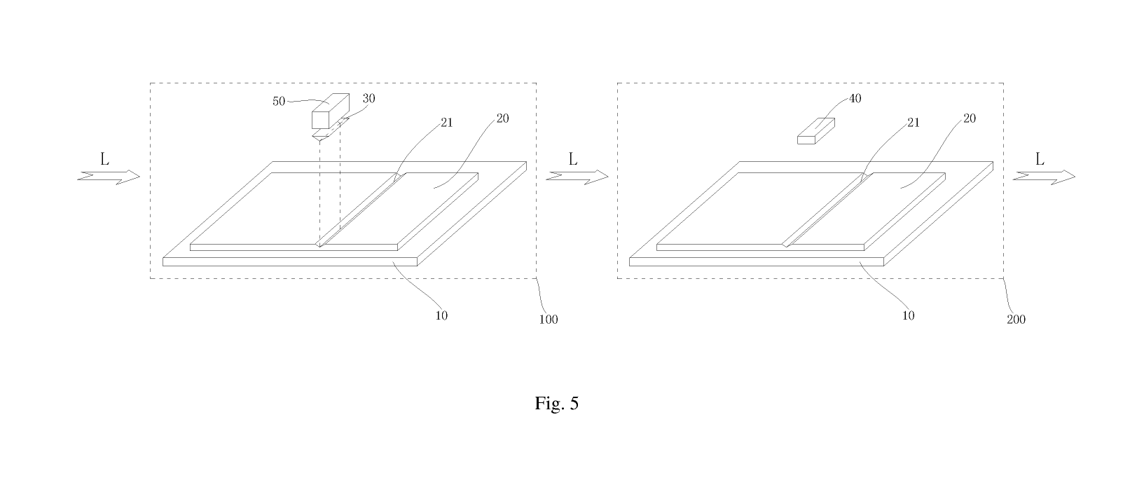

FIG. 5 is a diagram of a device for scribing and breaking a glass substrate according to a second embodiment of the present invention.

As shown in FIG. 5, in contrast to the first embodiment, in this embodiment, the scribing zone 100 further comprises a spraying device 50, which is positioned on the upper of the scribing device.

When the loading portion 10 loading the glass substrate 20 moves to a designated scribing position of the scribing zone 100, the scribing device is driven by a transmission device to scribe the glass substrate 20 along the scribing line such that a scribing notch 21 is formed. At the same time, the spraying device 50 sprays liquids to the scribing notch 21, where the liquids are in a form of tiny particles. When the loading portion 10 loading the glass substrate 20 moves to the breaking zone 200, there are liquids condensed on the scribing notch 21. Under the effect of supersonic waves, the micro foam of liquids condensed on the scribing notch is enlarged and closed very quickly such that these foams are collided to each other. This makes the breaking procedure easier.

In this embodiment, the spraying device 50 and the scribing device 30 can be fixed comparatively. For example, the spraying device 50 can be directly fixed on the scribing device 30. Or, the spraying device 30 can move comparatively to the scribing device 30. In addition, the liquids utilized by the spraying device 50 can be water to clean other solutions on the glass substrate 20. Or, the liquids utilized by the spraying device 50 can be organic liquids, which are easily vaporized, such as methyl, ethanol, glycol, acetone, or isopropanol.

Please note, the scribing zone 100 and the breaking zone 200 can be combined into one zone. That is, the scribing device 30 and the supersonic wave generator 40 can be placed in different positions of a single zone. After the scribing device 30 scribes the glass substrate 20 which arrives to the zone, the supersonic wave generator 40 then generates supersonic waves to the scribed glass substrate 20 to break the glass substrate 20 under the effect of supersonic waves.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for scribing and breaking a glass substrate, the method comprising:
scribing the glass substrate to form a scribing notch;
making a transmission medium of supersonic waves contact the scribing notch;
transmitting supersonic waves to the scribing notch via the transmission medium to break the scribed glass substrate under an effect of supersonic waves.

2. The method of claim 1, wherein the step of scribing the glass substrate to form the scribing notch comprises:
spraying liquids on the scribing notch such that some liquids are congealed on the scribing notch.

3. The method of claim 1, wherein the transmission medium is air.

4. The method of claim 2, wherein the liquids is water.

5. The method of claim 2, wherein the liquids is organic liquids.

6. The method of claim 5, wherein the liquids is ethanol.

7. The method of claim 5, wherein the liquids is glycol.

8. The method of claim 5, wherein the liquids is isopropanol.

9. A device for scribing and breaking a glass substrate, the device comprising:
a loading portion, for loading the glass substrate and moves the glass substrate to an assembling area;
a scribing device, positioned on an upper of a scribing zone, for scribing the glass substrate to form a scribing notch when the glass substrate arrives the scribing zone;
a supersonic wave generator, positioned on an upper of a breaking zone, for breaking supersonic waves when the glass substrate arrives the breaking zone; and
a transmission medium, for transferring the supersonic waves to the scribing notch to break the scribed glass substrate under an effect of supersonic waves.

10. The device of claim 9, further comprising:
a spraying device, positioned above the scribing device, for spraying liquids on the scribing notch.

11. The device of claim 9, wherein the transmission medium is air.

12. The device of claim 10, wherein the liquids is organic liquids.

13. The device of claim 12, wherein the liquids is ethanol.

14. The device of claim 12, wherein the liquids is glycol.

15. The device of claim 12, wherein the liquids is isopropanol.
